(19) United States
(12) Patent Application Publication
(10) Pub. No.: US 2026/0086708 A1
(43) Pub. Date: Mar. 26, 2026

(54) COMPUTING DEVICE WITH TOUCH GESTURE APPLICATION FUNCTION AND TOUCH GESTURE APPLICATION METHOD APPLIED THERETO

(71) Applicant: Primax Electronics Ltd., Taipei (TW)

(72) Inventors: Chih-Wei Huang, Taipei (TW); Chieh-Hung Hsieh, Taipei (TW); Wei-Ping Chan, Taipei (TW); Wei-Chiang Huang, Taipei (TW)

(21) Appl. No.: 18/928,782

(22) Filed: Oct. 28, 2024

(30) Foreign Application Priority Data
Sep. 25, 2024 (TW) 113136315

(51) Int. Cl. G06F 3/0488; G06F 3/01; G06F 3/04817; G06F 3/04895

(52) U.S. Cl. CPC G06F 3/0488; G06F 3/016; G06F 3/04817; G06F 3/04895

(57) ABSTRACT

A computing device includes a force touch pad, a processing module and a display screen. A database and a plurality of application programs are loaded in the computing device. A plurality of preset gesture patterns are stored in the database. Each preset gesture pattern is related to one of the application programs. Firstly, a startup input operation is performed on the force touch pad, so that a prompt panel is shown on the display screen. Then, a first gesture input operation is performed on the force touch pad with a first gesture by the user according to the prompt panel, and the first gesture input operation is recognized by the processing module. If the first gesture complies with one of the preset gesture patterns, the processing module executes the application program corresponding to the preset gesture pattern.

### FIELD OF THE INVENTION

The present invention relates to a computing device with a touch gesture application function and a touch gesture application method for the computing device, and more particularly to a computing device and an application method for recognizing touch gestures more precisely through the use of a force touch pad and the training of an artificial intelligence model.

### BACKGROUND OF THE INVENTION

Nowadays, notebook computers become essential tools for modern people in their daily lives. The user can operate an external mouse device to control a notebook computer. In addition, the notebook computer is usually equipped with a touch pad. The user can move a cursor or perform a clicking control operation through the touch pad.

Conventionally, the user’s finger can be moved or slid on the touch pad in a horizontal direction to perform a corresponding control operation. In recent years, a force touch pad or a pressure touch pad has been introduced into the market. The force touch pad or the pressure touch pad can be pressed and operated in a vertical direction. That is, when the pad surface of the force touch pad or the pressure touch pad is pressed down, heavily pressed or long pressed with the user’s fingers, the corresponding control functions can be triggered. Consequently, the operation of the force touch pad or the pressure touch pad can provide a more natural and intuitive control experience to users when compared with the familiar double click or multi-touch gestures.

In the conventional keyboard, the key structure usually has a special mechanical design to provide users with the key pressing feel. On the contrary, the force touch pad is equipped with some force sensors to firstly sense the touch condition of the user’s finger. After the touch condition of the user’s finger is sensed, a vibration motor generates a simulated pressing vibration feel to the user. Consequently, the user can recognize that the effective touch action has been completed.

Furthermore, when a user wants to open a related application program in the computer operating system, such as Word or Excel, the user usually monitors the display screen and touches the touch pad with a finger to move the cursor to the icon corresponding to the application program. After the icon is clicked, the application program is opened. Alternatively, related hardware and control instructions are specially designed, and thus the user can press a combination key of a keyboard to directly open the predetermined application program. Furthermore, the user can also slide on the touch pad in a preset manner with a related gesture to open the predetermined application program.

In case that the force touch pad has a vertical and three-dimensional pressing function, the types of touch gestures that can be recognized are much greater than those of the ordinary flat and two-dimensional touch pad.

Therefore, it is important to effectively utilize the characteristics of the force touch pad to increase the application diversity of touch gestures for users while increasing the recognition accuracy and providing the corresponding processing operations.

### SUMMARY OF THE INVENTION

In order to overcome the drawbacks of the conventional technologies, the present invention provides a computing device with a touch gesture application function and a touch gesture application method for the computing device. The computing device and the application method are capable of recognizing touch gestures more precisely through the use of a force touch pad and the training of an artificial intelligence model. When compared with the conventional two-dimensional image recognition technology, the technology of the present invention is more intuitive and diverse.

In accordance with an aspect of the present invention, a touch gesture application method for a computing device is provided. The computing device includes a force touch pad, a processing module and a display screen. A database is stored in the computing device. A plurality of preset gesture patterns are recorded in the database. A plurality of application programs are loaded in the computing device. Each of the preset gesture patterns is related to one of the application programs. The touch gesture application method includes the following steps. Firstly, a startup input operation is performed on the force touch pad by a user, so that the force touch pad enters an artificial intelligence application state and a prompt panel is shown on the display screen. Then, a first gesture input operation is performed on the force touch pad with a first gesture by the user according to the prompt panel, and the first gesture input operation is recognized by the processing module. If the first gesture complies with one of the preset gesture patterns, the processing module executes the application program corresponding to the preset gesture pattern. Then, a training process is performed by the processing module. In the training process, a second gesture input operation is performed on the force touch pad with a second gesture representing a self-defined gesture pattern by the user, the self-defined gesture pattern is correlated with an application program designed by the user, and the database is correspondingly edited.

In accordance with another aspect of the present invention, a computing device with a touch gesture application function is provided. The computing device includes a memory module, a force touch pad, a display screen and a processing module. The memory module stores a database. A plurality of preset gesture patterns are recorded in the database. A plurality of application programs are loaded in the memory module. Each of the preset gesture patterns is related to one of the application programs. When a startup input operation is performed on the force touch pad by a user, the force touch pad enters an artificial intelligence application state. When the force touch pad enters the artificial intelligence application state, a prompt panel is shown on the display screen to prompt the user. When a first gesture input operation is performed on the force touch pad with a first gesture by the user, the processing module recognizes the first gesture input operation. If the first gesture complies with one of the preset gesture patterns, the processing module executes the application program corresponding to the preset gesture pattern. When a training process is performed by the processing module, a second gesture input operation is performed on the force touch pad with a second gesture representing a self-defined gesture pattern by the user, the self-defined gesture pattern is correlated with an application program designed by the user, and the database is correspondingly edited.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the applications of a computing device according to an embodiment of the present invention;

FIG. 2 illustrates a flowchart illustrating the steps in an application stage of a touch gesture application method according to an embodiment of the present invention;

FIG. 3 schematically illustrates a prompt panel shown on the display screen in the application stage of the touch gesture application method; and

FIG. 4 illustrates a flowchart illustrating the steps in a training stage of the touch gesture application method according to the embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

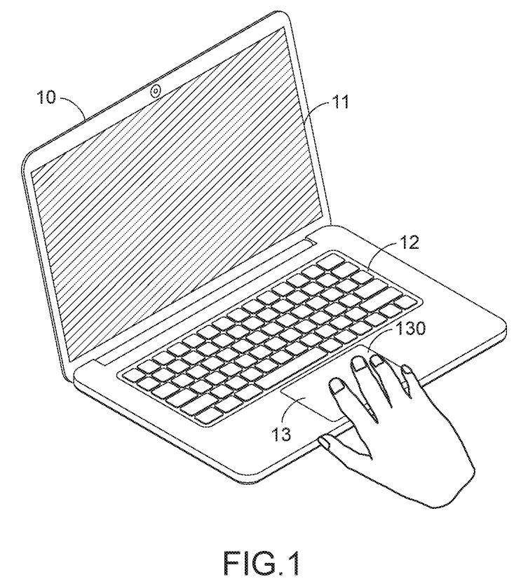

The present invention provides a computing device with a touch gesture application function and a touch gesture application method for the computing device. FIG. 1 schematically illustrates the applications of a computing device according to an embodiment of the present invention. As shown in FIG. 1, the computing device 10 includes a display screen 11, a keyboard 12 and a force touch pad 13. For example, the computing device 10 is a notebook computer. The force touch pad 13 is located beside the keyboard 12.

The computing device 10 further includes a processing module (not shown) and a memory module (not shown). The force touch pad 13 further includes a vibration module (not shown). The processing module is used to perform associated processing and recognizing operations in the touch gesture application method of the present invention. The vibration module generates the corresponding vibration action according to the processed and recognized results of the processing module.

In accordance with a feature of the present invention, a database has been stored in the memory module after the setting of the computing device is completed or the associated application functions for the user have been initially provided. In addition, a plurality of preset gesture patterns are recorded in the database. Furthermore, an operating system and a plurality of application programs are loaded in the memory module. For example, these application programs include Word or Excel. In addition, each of the preset gesture patterns corresponds to one of these application programs.

As mentioned above, each of the force touch pad 13 and the keyboard 12 is served as a user interface or a control panel for allowing the user to perform associated operations with one or more fingers. The force touch pad 13 includes a touch surface 130. The cursor displayed by the loaded operating system in the computing device 10 can be horizontally moved or slid on the touch surface 130. Alternatively, the icons or function options represented by the loaded application programs in the computing device 10 can be clicked or controlled in a vertical pressing manner.

The touch gesture application method of the present invention has the following features.

Firstly, the preset gesture patterns in the preset database are used to recognize or infer the user’s touch trajectory or gesture pattern. After the user’s touch trajectory or gesture pattern is recognized, the corresponding application program is opened. Consequently, the purpose of quickly opening the application program can be achieved.

Secondly, due to the vertical and three-dimensional pressing function of the force touch pad, the magnitude of the pressing force (i.e., the depth) of the user’s finger can be acquired. Furthermore, when the user’s finger is pressed on the force touch pad and moved or slid horizontally, the trajectory and the speed of the user’s finger can be tracked. Consequently, the information about the user’s input operation can be processed into a trajectory pattern with four-dimensional data. After the user’s gesture with the four-dimensional data is trained through an artificial intelligence (AI) model, a more accurate recognition target can be obtained. Consequently, the recognition error rate in subsequent applications will be reduced.

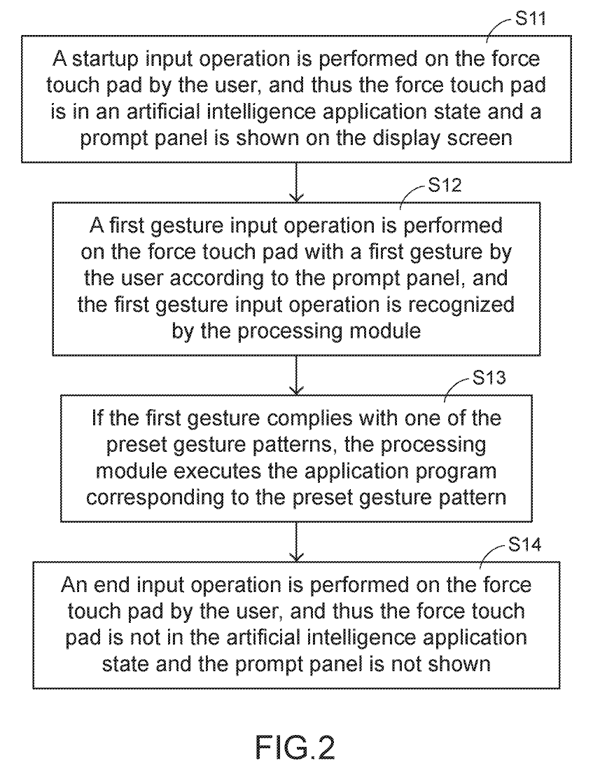

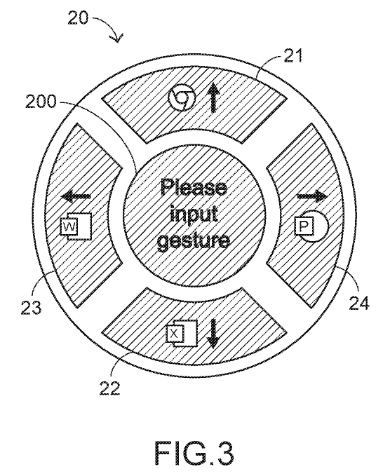

Please refer to FIGS. 2 and 3. FIG. 2 illustrates a flowchart illustrating the steps in an application stage of a touch gesture application method according to an embodiment of the present invention. FIG. 3 schematically illustrates a prompt panel shown on the display screen in the application stage of the touch gesture application method.

Please refer to FIG. 2. Firstly, a startup input operation is performed on the force touch pad 13 by the user, and thus the force touch pad 13 is in an artificial intelligence application state and a prompt panel 20 is shown on the display screen 11 (Step S11). Then, a first gesture input operation is performed on the force touch pad 13 with a first gesture by the user according to the prompt panel 20, and the first gesture input operation is recognized by the processing module (Step S12). If the first gesture complies with one of the preset gesture patterns, the processing module executes the application program corresponding to the preset gesture pattern (Step S13). Afterwards, an end input operation is performed on the force touch pad 13 by the user, and thus the force touch pad 13 is not in the artificial intelligence application state and the prompt panel 20 is not shown (Step S14).

Generally, the force touch pad 13 in the normal touch state still provides the horizontal movement and sliding control of the cursor displayed by the operating system. In the step S11, for using the force touch pad 13 to operate the touch gesture application method of the present invention, a switching mechanism is required to stop the normal horizontal movement and sliding control function of the force touch pad 13 at first. For example, according to the settings, the startup input operation is performed after the touch surface 130 of the force touch pad 13 has been pressed with at least two fingers of the user for a specified time period. For example, after the touch surface 130 of the force touch pad 13 has been pressed with three fingers of the user for 1 second, the original state of the force touch pad 13 is switched to the artificial intelligence application state.

It is noted that the design of performing the startup input operation is not restricted. For example, in another embodiment, the touch surface 130 of the force touch pad 13 is pressed with two or four fingers of the user, or the touch surface 130 of the force touch pad 13 has been pressed for a longer time period to perform the startup input operation. According to the designing concepts, the design of performing the startup input operation is distinguished from the general horizontal movement and sliding control function or the general clicking and vertical pressing control function. Alternatively, the startup input operation is performed when a combination key of the keyboard 12 is pressed down.

As mentioned above, in case that the startup input operation is not performed with the preset start gesture, the force touch pad 13 will not enter the artificial intelligence application state. That is, the force touch pad 13 is maintained in the normal touch state. In accordance with the present invention, the startup gesture corresponding to the startup input operation is obviously distinguished from the general control gesture. Consequently, it is not easy to change the application state due to an unintentional touch by the user.

In the above embodiment, the prompt panel 20 is shown on the display screen 11 in a visual feedback manner to inform the user that the force touch pad 13 has now entered the artificial intelligence application state. In some other embodiments, the current state is informed to the user in a tactile feedback manner. Consequently, according to the characteristics of the force touch pad 13, the step S11 further includes the following steps. When the force touch pad 13 enters the artificial intelligence application state, the processing module sends a feedback command to the vibration module to cause the vibration module to generate vibration. For example, the vibration module vibrates three times quickly and successively or the vibration module vibrates continuously for one second.

It is noted that the vibration frequency and the vibration number of the vibration module are not restricted. For example, the vibration module may vibrate twice successively and slowly, or the vibration module may vibrate continuously for two seconds. According to the designing concepts, the vibration is distinguished from the simulated pressing vibration feedback in response to the general clicking and vertical pressing control function.

As shown in FIG. 3, the prompt panel 20 shown on the display screen 11 has a plurality of prompt icons. In this embodiment, four prompt icons 21, 22, 23 and 24 are used as examples for explanation, and each prompt icon corresponds to one of the preset gesture patterns. For example, the contents of the prompt icons 21, 22, 23 and 24 are respectively related to an upward pattern, a downward pattern, a leftward pattern and a rightward pattern and respectively related to the four application programs corresponding to the four preset gesture patterns.

For example, the prompt icon 21 contains an upward arrow and a browser icon, the prompt icon 22 contains a downward arrow and an Excel icon, the prompt icon 23 contains a leftward arrow and a Word icon, and the prompt icon 24 contains a rightward arrow and a PowerPoint icon. A prompt message “Please input gesture” is also shown on a prompt area 200 of the prompt panel 20. That is, the prompt message is used to prompting the user to perform the touching and drawing input operation on the touch surface 130 of the force touch pad 13 according to the prompt of each icon.

In the step S12, the first gesture input operation is performed when the touch surface 130 of the force touch pad 13 is touched, drawn and slid with a single finger of the user in the direction from the middle to the top (or from the bottom to the top), in the direction from the middle to the bottom (or from the top to the bottom), in the direction from the middle to the left (or from the right to the left) or in the direction from the middle to the right (or from the left to the right). In addition, the first gesture input operation is recognized by the processing module. The processing module recognizes the first gesture input operation according to an artificial intelligence model downloaded to the memory module through a driver. In an embodiment, the artificial intelligence model is a general open artificial intelligence driver that can be downloaded and used by ordinary people through the Internet, and the artificial intelligence model is related to the stored database.

In the above embodiment, the above four prompt icons 21, 22, 23 and 24 are not simple 1-shaped patterns according to the characteristics of the force touch pad 13 and the characteristics of the artificial intelligence model. By recognizing user’s strokes and direction trajectories corresponding to the first gesture, it is possible to recognize one of the four prompt icons 21, 22, 23 and 24 complies with the first gesture. In addition, each of the prompt icons corresponds to one of the preset gesture patterns. In other words, the preset gesture patterns in the database already contain the data about the time dimension during the training, recognition and recording procedures in the preset stage. After the processing module accesses the database in the artificial intelligence application state, the processing module can recognize whether the trajectory pattern of the first gesture that is processed into the four-dimensional data has the complied record in the database.

It is noted that the prompt icons are not restricted to the above four prompt icons 21, 22, 23 and 24. The examples of the prompt icons may be varied according to the practical requirements. For example, in addition to the four directions (upward, downward, leftward and rightward directions), four diagonal directions are added. That is, there are eight prompt icons. However, as the number of the present directions increases, the drawing precision of the user’s gesture decreases. When compared with the conventional two-dimensional image recognition technology that cannot recognize strokes or force (i.e., depth), the technologies of the present invention can achieve a significant improvement in recognition precision.

For example, if “6” and “8” are set as preset gesture patterns, the user’s finger may write “6” like “θ”. The use of the conventional two-dimensional image recognition technology may erroneously judge the image as “8”, and thus the subsequent application errors are generated. However, since the technology of the present invention introduces the stroke data about the time dimension, the difference between the strokes of “6” and “8” can be easily distinguished. According to the writing trajectory, the processing module can recognize whether the user’s gesture corresponds to “6” or “8”. Consequently, the application program that the user wants to use can be opened more accurately.

In the step S13, if the processing module compares the user’s first gesture with the preset gesture patterns in the database and finds that the first gesture complies with one of the preset gesture patterns, the processing module executes the application program corresponding to the complied preset gesture pattern.

Please refer to FIG. 3 again. When the touch surface 130 of the force touch pad 13 is touched and slid with a single finger of the user in the direction from the middle to the top (or from the bottom to the top), the gesture complies with a preset gesture pattern with a trajectory in the direction from the middle to the top (or from the bottom to the top) in the database. Consequently, the operating system activates the application program corresponding to this pattern. That is, the browser is opened.

For providing the prompt panel 20 with the succinct visual effect, only four simple gestures are taken as examples in FIG. 3. It is noted that more preset gesture patterns may be stored in the database. That is, the user can also quickly open more other application programs. For example, in case that the database has a preset gesture pattern “@” corresponding to an email program, the user remembering this preset gesture pattern can write “@” on the touch surface 130 of the force touch pad 13. Consequently, the email program can be opened.

In some other embodiments, more preset gesture patterns are shown on the prompt panel 20 in another way to prompt the user. For example, after a specified key of the keyboard 12 is pressed, a function menu is popped up and shown on the display screen 11. The function menu contains the images of other preset gesture patterns and the icons or texts of the corresponding application programs. The user can view them firstly, and then perform corresponding touching, drawing and sliding actions on the touch surface 130. Consequently, the desired application program can be quickly opened.

After the application program required by the user is successfully opened, the artificial intelligence application state can be ended. That is, the force touch pad 13 can be restored to the general control state. Similarly, the means of performing the end input operation in the step S14 is similar to the above means of performing the startup input operation. That is, the procedure of performing the end input operation is distinguished from the general moving, sliding, clicking and pressing control procedures. In an embodiment, the means of performing the end input operation is identical to the above means of performing the startup input operation. For example, after the touch surface 130 of the force touch pad 13 has been pressed with three fingers of the user for 1 second, the force touch pad 13 can terminate the artificial intelligence application state and stop displaying the prompt panel 20.

Of course, the means of performing the end input operation may be different from the means of performing the startup input operation. For example, in another embodiment, the end input operation is performed when a combination key of the keyboard 12 is pressed down. In order to remind the user that the current state has changed, the step S14 may be modified. When the force touch pad 13 terminates the artificial intelligence application state, the processing module sends a feedback command to the vibration module to cause the vibration module to generate vibration. For example, the vibration module vibrates three times quickly and successively or the vibration module vibrates continuously for one second.

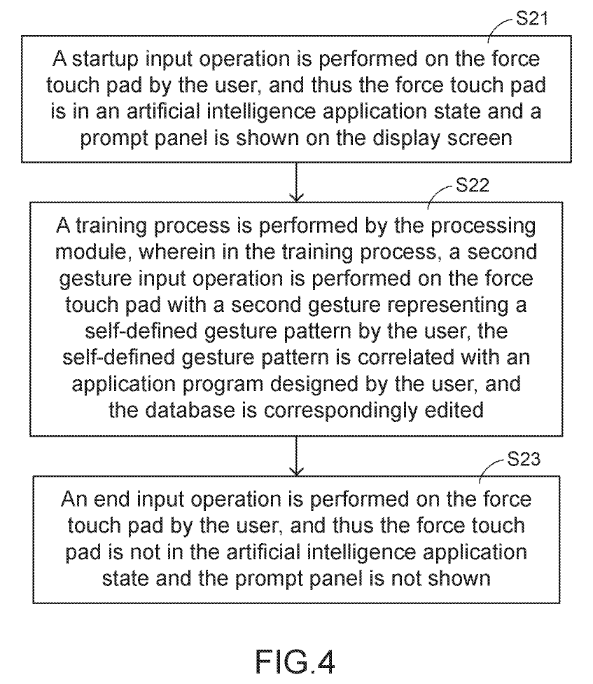

FIG. 4 illustrates a flowchart illustrating the steps in a training stage of the touch gesture application method according to the embodiment of the present invention. As mentioned above, the touch gesture application method of the present invention can be directly applied to the application stage shown in FIG. 3 according to the preset contents of the database. Furthermore, the user can utilize the artificial intelligence model to train the self-defined gestures and edit, modify or add the contents of the database.

Please refer to FIG. 4. Firstly, a startup input operation is performed on the force touch pad 13 by the user, and thus the force touch pad 13 is in an artificial intelligence application state and a prompt panel 20 is shown on the display screen 11 (Step S21). Then, in a step S22, the processing module performs a training process. In the training process, a second gesture input operation is performed on the force touch pad 13 with a second gesture representing a self-defined gesture pattern by the user. The self-defined gesture pattern is correlated with an application program designed by the user. In addition, the database is correspondingly edited. Afterwards, an end input operation is performed on the force touch pad 13 by the user, and thus the force touch pad 13 is not in the artificial intelligence application state and the prompt panel 20 is not shown (Step S23).

The step S21 in the training stage is identical to the step S11 in the application stage. That is, when the force touch pad 13 is switched to the artificial intelligence application state, the training process can be performed. Similarly, the vibration module can generate vibration and provide tactile feedback to the user. For brevity, associated descriptions are omitted herein.

In the step S22, the second gesture of the user is a self-defined gesture. Like the above-mentioned first gesture, the information about the second gesture can be processed into a trajectory pattern with four-dimensional data. That is, the four-dimensional data contains the vertical direction data and the time dimension data according to the writing strokes, directions or forces (i.e., depths) of the user. In this embodiment, the processing module implements the training process through a designated artificial intelligence algorithm. The designated artificial intelligence algorithm is determined according to the artificial intelligence model loaded by the user.

Like the general artificial intelligence technology, the training or learning procedures of the present invention require multiple times of inputs and identifications. Consequently, the subsequent input behaviors can be accurately predicted or inferred. In the training process of the present invention, a specified number of multiple input operations are performed on the force touch pad 13 with the second gesture by the user, and the second gesture input operation is recognized by the processing module.

For example, the second gesture representing the self-defined gesture pattern is a triangle pattern “Δ”, and the second gesture of the user may be slightly different each time during the training process. However, through the training and learning processes of the artificial intelligence model and the collected and accumulated data, the results of drawing the triangle pattern with the same stroke can generate the output results expected by the user in the subsequent inference stage. That is, these results are all recognized as the self-defined gesture pattern.

Secondly, in an embodiment, a function menu is popped up and shown on the display screen 11 after the second gesture is inputted and a specified key of the keyboard 12 is pressed. The function menu contains the icons or texts of other application programs. The user can use the up, down, left, and right keys and the Enter key of the keyboard 12 to designate the self-defined gesture pattern as the corresponding application program.

In accordance with another embodiment of the present invention, the artificial intelligence model can be operated in a network offline state. For example, after the input operation corresponding to the second gesture is assigned to the corresponding application program, the processing module can perform the calculation without the need of connecting to the network. In the network offline state, the hardware resources of the computing device 10 are utilized. The training process is performed under a computing background of the operating system. That is, other tasks can still be performed by the user under the operating system, and the calculations of the training process can be executed in the idle time of the processing module.

Due to this design, the computation time of the training process will be longer. That is, it will take a longer time to establish the recognition of the second gesture in the artificial intelligence model. However, the used computing device does not need to be additionally equipped with a graphics processing unit (GPU). Consequently, a general low-end computing device can also perform the touch gesture application method of the present invention. After the database is correspondingly edited, the self-defined gesture pattern becomes a preset gesture pattern in the database. In addition, a corresponding application can be provided for recognition in the next application stage.

The step S23 in the training stage is identical to the step S14 in the application stage. That is, after the input operation corresponding to the second gesture is assigned to the corresponding application program, the force touch pad 13 can be restored to the general control function. Similarly, the vibration module can generate vibration and provide tactile feedback to the user. For brevity, associated descriptions are omitted herein.

Furthermore, the application stage and the training stage of the touch gesture application method of the present invention can be executed successively. For example, the training stage is performed after the application stage, or the application stage is performed after the training stage. That is, after the force touch pad enters the artificial intelligence application state, the sequence can be selected according to the user’s requirements. In addition, the preset application programs that are opened through the uses of the above gestures are not necessarily subsidiary programs. That is, functional instructions are possibly used as the preset application programs. For example, the functional instruction for muting the operating system or taking a screenshot may be used as the preset application programs as long as the functional instruction is executable by the computing device.

From the above descriptions, the present invention provides a computing device with a touch gesture application function and a touch gesture application method for the computing device. When compared with the conventional technologies, the technologies of the present invention are more advantageous. Firstly, the information about the user’s input operation can be processed into a trajectory pattern with four-dimensional data according to the characteristics of the force touch pad. Consequently, a more accurate recognition target can be obtained, and the recognition error rate in subsequent applications will be reduced. Secondly, the user can open different application programs with very simple stroke patterns according to the characteristics of the force touch pad. Consequently, the technology of the present invention is more intuitive and more diverse than conventional two-dimensional image recognition technologies. Thirdly, the training process is performed on the artificial intelligence model under the computing background of the operating system. Consequently, the touch gesture application method of the present invention can be applied to the general low-end computing device. That is, the used computing device does not need to be additionally equipped with a graphics processing unit (GPU).

The technologies of the present invention can effectively solve the related problems existing in the prior art. Consequently, the main purpose of the present invention can be successfully achieved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touch gesture application method for a computing device, the computing device comprising a force touch pad, a processing module and a display screen, a database being stored in the computing device, a plurality of preset gesture patterns being recorded in the database, a plurality of application programs being loaded in the computing device, each of the preset gesture patterns being related to one of the application programs, the touch gesture application method comprising steps of:
performing a startup input operation on the force touch pad by a user, so that the force touch pad enters an artificial intelligence application state and a prompt panel is shown on the display screen;
performing a first gesture input operation on the force touch pad with a first gesture by the user according to the prompt panel, and recognizing the first gesture input operation by the processing module;
if the first gesture complies with one of the preset gesture patterns, the processing module executing the application program corresponding to the preset gesture pattern; and
performing a training process by the processing module, wherein in the training process, a second gesture input operation is performed on the force touch pad with a second gesture representing a self-defined gesture pattern by the user, the self-defined gesture pattern is correlated with an application program designed by the user, and the database is correspondingly edited.

2. The touch gesture application method according to claim 1, wherein the force touch pad further comprises a vibration module, and the touch gesture application method further comprises a step of sending a feedback command from the processing module to the vibration module to cause the vibration module to generate vibration when the force touch pad enters the artificial intelligence application state.

3. The touch gesture application method according to claim 1, wherein the computing device further comprises a keyboard, wherein the startup input operation is performed when a combination key of the keyboard is pressed down, or the startup input operation is performed after a touch surface of the force touch pad has been pressed with at least two fingers of the user for a specified time period.

4. The touch gesture application method according to claim 1, wherein the touch gesture application method further comprises a step of performing an end input operation on the force touch pad by the user, so that the force touch pad is not in the artificial intelligence application state and the prompt panel is not shown.

5. The touch gesture application method according to claim 4, wherein the computing device further comprises a keyboard, wherein the end input operation is performed when a combination key of the keyboard is pressed down, or the end input operation is performed after a touch surface of the force touch pad has been pressed with at least two fingers of the user for a specified time period.

6. The touch gesture application method according to claim 4, wherein the force touch pad further comprises a vibration module, and the touch gesture application method further comprises a step of sending a feedback command from the processing module to the vibration module to cause the vibration module to generate vibration when the force touch pad ends the artificial intelligence application state.

7. The touch gesture application method according to claim 1, wherein the prompt panel has a plurality of prompt icons, and each of the prompt icons is related to one of the preset gesture patterns.

8. The touch gesture application method according to claim 7, wherein the prompt icons are respectively related to an upward pattern, a downward pattern, a leftward pattern and a rightward pattern and respectively related to the application programs corresponding to four of the preset gesture patterns.

9. The touch gesture application method according to claim 1, wherein an artificial intelligence model is loaded in the computing device, the processing module implements the training process through a designated artificial intelligence algorithm, and the designated artificial intelligence algorithm is determined according to the artificial intelligence model, wherein the artificial intelligence model is operated in a network offline state.

10. The touch gesture application method according to claim 9, wherein the database is related to the artificial intelligence model, and the processing module accesses the database when the force touch pad is in the artificial intelligence application state.

11. The touch gesture application method according to claim 1, wherein in the training process, a specified number of multiple input operations are performed on the force touch pad with the second gesture by the user, and the second gesture input operation is recognized by the processing module.

12. The touch gesture application method according to claim 1, wherein the training process is performed under a computing background of an operating system of the computing device.

13. The touch gesture application method according to claim 1, wherein the first gesture and the second gesture are processed into trajectory patterns with four-dimensional data.

14. A computing device with a touch gesture application function, the computing device comprising:
a memory module storing a database, wherein a plurality of preset gesture patterns are recorded in the database, a plurality of application programs are loaded in the memory module, and each of the preset gesture patterns is related to one of the application programs;
a force touch pad, wherein when a startup input operation is performed on the force touch pad by a user, the force touch pad enters an artificial intelligence application state;
a display screen, wherein when the force touch pad enters the artificial intelligence application state, a prompt panel is shown on the display screen to prompt the user; and
a processing module, wherein when a first gesture input operation is performed on the force touch pad with a first gesture by the user, the processing module recognizes the first gesture input operation,
wherein if the first gesture complies with one of the preset gesture patterns, the processing module executes the application program corresponding to the preset gesture pattern,
wherein when a training process is performed by the processing module, a second gesture input operation is performed on the force touch pad with a second gesture representing a self-defined gesture pattern by the user, the self-defined gesture pattern is correlated with an application program designed by the user, and the database is correspondingly edited.
